(19) United States
(12) Patent Application Publication
(10) Pub. No.: US 2008/0206603 A1
(43) Pub. Date: Aug. 28, 2008

(54) Arrangement Having a Battery

(76) Inventors: Helmut Bacic, Konigsfeld (DE); Ulf Bartholomaus, St. Georgen (DE); Gerhard Rombach, Triberg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/599,222

(22) PCT Filed: Mar. 10, 2005
(86) PCT No.: PCT/EP2005/051076

§ 371 Date: Sep. 22, 2006

(30) Foreign Application Priority Data
Mar. 25, 2004 (DE) 10 2004 014 136.3

(51) Int. Cl. H01M 2/30; H01M 2/34

(52) U.S. Cl. 429/7; 429/178; 320/135

(57) ABSTRACT

A system (1) has a battery (2) provided with a first contact pole (9), a second contact pole (10) and two connection lines (3, 4) each of which has the first (11) and second (12) ends associated with the contact pole (9, 10) in such a way that one end is electrically connected to the pole on the first end (11, 12) and the other is connectable to a user on the second end (21, 22). In the presence of dangerous products, conventional systems involve short circuit risks resulting from inadmissible temperature development. A remedy is provided in which the first end (11) of the connection line (3) is assigned to the end of the first contact pole (9) and a constant-ohmic resistance (30) is electrically connected to the first contact pole (9).

### CROSS-REFERENCE TO RELATED APPLICATIONS

This application is a U.S. national stage application of International Application No. PCT/EP2005/051076 filed Mar. 10, 2005, which designates the United States of America, and claims priority to German application number DE 10 2004 014 136.3 filed Mar. 23, 2004, the contents of which are hereby incorporated by reference in their entirety.

### TECHNICAL FIELD

The invention relates to an arrangement having a battery with a first contact pole and a second contact pole, having a first connecting line and a second connecting line, which connecting lines each have a first end and a second end, and are each associated with one contact pole to which they are electrically conductively connected at a first end, and which connecting lines can make contact with a load at a second end.

### BACKGROUND

Arrangements such as these are widely used as permanently installed power sources in relatively small electrical appliances in which the power consumptions are minimal. By way of example, this ensures uninterrupted power supplies for clocks, even during a power failure, in appliances which draw their actual supply voltage from an electricity supply network, for example the local mains system or the voltage supply in a motor vehicle. In order that certain functions of appliances, for example the time of day in a tachigraph, are electrically buffered in the event of a power failure, for example in a motor vehicle, arrangements as described above having a battery are installed in the appropriate appliances, with a predicted life, depending on the operating mode, of about three years. Furthermore, buffering of the power supply in this way has the advantage that it improves the resistance to manipulation, since the function being protected normally requires an intact, uninterrupted power supply.

Conventional arrangements having a battery involve the risk of an explosion in the event of a short-circuit when used in commercial vehicles which transport highly inflammable hazardous goods.

### SUMMARY

The object of the invention is thus to reduce to a minimum the risk of explosion when using an arrangement having a battery of the type mentioned in the introduction in a hazardous-goods transporter.

In order to achieve the object according to the invention, the invention proposes that an ohmic, fixed-value resistor is arranged such that it is electrically conductively connected between the first end of the connecting line which is associated with the first contact pole and the first contact pole. The ohmic fixed-value resistor which is arranged connected electrically in series between the first contact pole and the first end of the connecting line ensures that, in the event of a short-circuit occurring downstream from the ohmic fixed resistor, the maximum current is in all circumstances limited by the fixed-value resistor, and in consequence the heat produced by the short-circuit can produce only a limited temperature. If the resistance value is expediently chosen, the temperature increase caused by a short-circuit can be kept sufficiently small that it is impossible for any hazardous goods to be ignited or to explode.

Major advantages of the solution according to the invention are the low costs for intrinsic safety of a voltage source, the additional safety during handling, in particular during the course of installation and storage of the battery, the lack of any requirements for subsequent plug systems and circuit areas in the appliance, as well as the compatibility with previous battery plug systems.

In order to ensure that the fixed-value resistor, which is so important for the safety of the voltage source, cannot assume an uncontrolled position, it is expedient for the battery to have a housing, and for the fixed-value resistor to be attached directly to the housing. One advantageous development of the invention provides that the housing has two opposite end faces, and one contact pole is arranged on each end face of the housing. This means that the two contact poles between which a direct conductive connection or a short-circuit must be avoided, are as far away from one another as possible. In order to prevent an electrically conductive connection between the two contact poles without the interposition of the fixed-value resistor in all circumstances, it is worthwhile for the fixed-value resistor to be attached to the housing in the area between the two planes which are described by the end faces. The attachment can cost-effectively satisfy the requirements for robustness of the attachment as well as electrical isolation completely sufficiently by means of a shrink sleeve on the housing, with the shrink sleeve jointly surrounding the housing and the fixed-value resistor.

Particularly widespread use of the invention is ensured by the battery being a cylindrical AA-format cell, with the fixed-value resistor being arranged on and attached to the cylindrical casing surface between the two end faces. The use of a ½-AA-format battery is worthwhile for some applications, in particular when only a small amount of physical space is available.

In order to comply with the relevant regulations, it is expedient for the fixed resistor to have a rated value of 100Ω when the battery rated voltage is 3.6 volts. The rated power of the fixed resistor can in this case be designed to be 250 mW, in order to maintain its function in all circumstances. This results in the power source being comparatively intrinsically safe, since the battery body is not heated by more than 10 K in the event of a short-circuit, even when the ambient temperature is about 70° C. Depending on the battery type used, the rated capacity may be between 0.5-2.25 Ah.

The arrangement according to the invention is particularly cost-effective if a carbon-film resistor is used, and it has been found to be particularly reliable if a metal-film resistor is used.

The assembly of the arrangement according to the invention is particularly simple if the connecting lines are each electrically conductively connected at a second end to a plug of a plug connection.

In order to satisfy additional safety requirements, it is worthwhile separately electrically isolating the contact poles and the electrical contact with the contact poles from the environment. If, for example, the contact pole projects out of one end surface, as is frequently the case with commercially-available batteries, it is worthwhile electrically isolating the area around the contact pole from the environment by means of insulation in the form of a disk, in particular in the form of an annular disk. Because of the dimensions of commercially-available batteries, it has been found to be expedient for the first contact pole of the battery, with which the fixed-value resistor makes contact, to be a negative pole. In order to allow easier handling of the arrangement according to the invention, the first connecting line and the second connecting line can advantageously be non-conductively connected to one another in places.

### BRIEF DESCRIPTION OF THE DRAWINGS

The invention will be described in more detail, for explanatory purposes, in the following text with reference to one specific exemplary embodiment. Numerous other design options will be evident to a person skilled in the art from this exemplary embodiment of the invention described here. In particular, the invention also includes feature combinations which result from combinations of the claims, even if no express corresponding back-reference is stated. In the figure:

FIG. 1 shows a schematic illustration of an arrangement according to the invention having a battery.

### DETAILED DESCRIPTION

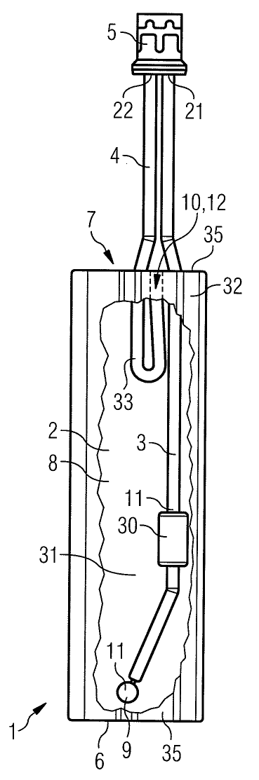

The arrangement 1 illustrated in FIG. 1 and having a battery 2 essentially also has a first connecting line 3 with a fixed resistor 30, and a second connecting line, which open into a common two-pole plug 5. A housing 31 for the battery 2 has a cylindrical shape with a first end face 6 and a second end face 7, as well as a casing surface 8. A contact pole 9, 10 is respectively arranged on each of the two end faces 6, 7. The first contact pole 9 on the first end face 6 is electrically conductively connected via a fixed-value resistor 30 to the first end 11 of the first connecting line 3. The first contact pole 9 is the negative pole of the battery 2. The second contact pole 10 is electrically conductively connected to the first end 12 of the second connecting line 4 which is guided along the housing 31 of the battery 2 in a small loop 33, and then extends parallel to the first connecting line 3 in the direction of the plug 5. The first connecting line 3 and the second connecting line 4 are attached at their second ends 21, 22 to a respective pole of the plug 5 of a plug connection which is not illustrated, and make electrically conductive contact with it. The fixed resistor 30 is attached to the casing surface 8 of the housing 31 of the battery 2 by means of a shrink sleeve 32, with the shrink sleeve at the same time fixing sections of the connecting lines 3, 4, in particular the loop 33, on the housing 31, and additionally isolating the arrangement from the environment. The battery 2 is provided with insulation 35 on each of its end faces.

What is claimed is:

1. An arrangement having a battery with a first contact pole and a second contact pole, having a first connecting line and a second connecting line, which connecting lines each have a first end and a second end and are each associated with one contact pole to which they are electrically conductively connected at a first end, and which connecting lines can make contact with a load at a second end and an ohmic fixed-value resistor is electrically conductively connected between the first end of the connecting line, which is associated with the first contact pole, and the first contact pole, wherein the battery comprises a housing which has two opposite end faces, and one contact pole is arranged on each end face of the housing, and the fixed-value resistor is attached to the housing in the area between two planes which are described by the end faces.

2. The arrangement according to claim 1, wherein the fixed-value resistor is attached to the housing by means of a shrink sleeve.

3. The arrangement according to claim 1, wherein the battery is a cylindrical AA-format cell, with the fixed-value resistor-being arranged on and attached to the cylindrical casing surface between the two end faces.

4. The arrangement according to claim 1, wherein the battery is a cylindrical ½-AA-format cell, with the fixed-value resistor being arranged on and attached to the cylindrical casing surface between the two end faces.

5. The arrangement according to claim 1, wherein the battery has a rated voltage of 3.6 V and the fixed-value resistor has a rated value of 100Ω.

6. The arrangement according to claim 5, wherein the fixed-value resistor has a rated power of 250 mW.

7. The arrangement according to claim 1, wherein the battery is a lithium battery, in particular a thionyl-chloride system battery.

8. The arrangement according to claim 1, wherein the fixed-value resistor is in the form of a metal-film resistor or a carbon-film resistor.

9. The arrangement according to claim 1, wherein the connecting lines are each electrically conductively connected at a second end to a plug of a plug connection.

10. The arrangement according to claim 1, wherein the contact poles and the electrical contact with the contact poles are electrically isolated from the environment.

11. The arrangement according to claim 1, wherein the first contact pole of the battery is a negative pole.

12. The arrangement according to claim 1, wherein the first connecting line and the second connecting line are non-conductively connected to one another in places.

13. A battery comprising:
a first contact pole and a second contact pole,
a first connecting line and a second connecting line each having a first end and a second end and each being associated with one contact pole to which they are electrically conductively connected at a first end, wherein the connecting lines can make contact with a load at a second end,
a ohmic fixed-value resistor electrically conductively connected between the first end of the connecting line, which is associated with the first contact pole, and the first contact pole,
a housing having two opposite end faces, wherein one contact pole is arranged on each end face of the housing, and wherein the fixed-value resistor is attached to the housing in the area between two planes defined by the end faces.

14. The battery according to claim 12, wherein the fixed-value resistor is attached to the housing by means of a shrink sleeve.

15. The battery according to claim 12, wherein the battery is a cylindrical AA-format cell, with the fixed-value resistor being arranged on and attached to the cylindrical casing surface between the two end faces.

16. The battery according to claim 12, wherein the battery is a cylindrical ½-AA-format cell, with the fixed-value resistor being arranged on and attached to the cylindrical casing surface between the two end faces.

17. The arrangement according to claim 12, wherein the battery has a rated voltage of 3.6 V and the fixed-value resistor has a rated value of 100Ω and the fixed-value resistor has a rated power of 250 mW.

18. The arrangement according to claim 12, wherein the battery is a lithium battery, in particular a thionyl-chloride system battery.

19. The arrangement according to claim 12, wherein the fixed-value resistor is in the form of a metal-film resistor or a carbon-film resistor.

20. The arrangement according to claim 12, wherein the connecting lines are each electrically conductively connected at a second end to a plug of a plug connection.
